(19) United States
(12) Patent Application Publication
(10) Pub. No.: US 2003/0031412 A1
(43) Pub. Date: Feb. 13, 2003

(54) Optical arrayed waveguide grating devices

(76) Inventors: Frank Payne, Cambridge (GB); Stephane Paquet, Bishop's Stortford (GB); Terry Bricheno, Gt Sampford (GB)

Correspondence Address: Lee, Mann, Smith, McWilliams, Sweeney & Ohlson, P.O. Box 2786, Chicago, IL, 60690-2786, US

(21) Appl. No.: 10/037,883

(22) Filed: Jan. 4, 2002

Related U.S. Application Data
(60) Provisional application No. 60/311,583, filed on Aug. 13, 2001.

(51) Int. Cl. G02B 6/34

(52) U.S. Cl. 385/37

(57) ABSTRACT

An arrayed waveguide device comprises a plurality of input/output 2-dimensional optical waveguides optically that are coupled, by a radiative star coupler 1-dimensional waveguide region, with an arrayed waveguide grating constituted by a set of retro-reflector terminated 2-dimensional optical waveguides in side-by-side array so as to define a set of reflex optical paths extending from that star coupler region, each path being of incrementally greater optical path length from a shortest value at one side of the array to a longest value at the other.

This non-provisional patent application claims the benefit of U.S. Provisional Application No. 60/311,583 filed on Aug. 13, 2001 titled “Optical Arrayed Waveguide Grating Devices” by inventors Frank P. Payne, Stephane Paquet and Teny Bricheno.

### FIELD OF THE INVENTION

This invention relates to optical arrayed waveguide grating (AWG) devices, particularly such devices suitable for use as optical wavelength multiplexers, demultiplexers, or filters. Such devices find particular, but not necessarily exclusive, application in wavelength division multiplexed (WDM) optical transmission systems.

### BACKGROUND TO THE INVENTION

WDM optical transmission systems ideally require passive optical wavelength multiplexers, demultiplexers and filters. Typically, but not necessarily, these will have isolated pass-bands which are relatively flat-topped so as to allow a measure of tolerance in the spectral positioning of the individual signals of the WDM system within these pass-bands. One method of multiplexing, demultiplexing or filtering channels in an optical. WDM system relies upon the use of multilayer dielectric interference filters. Another relies upon Bragg reflection effects created in optical fibres. A third method, the method with which the present invention is particularly concerned, relies upon diffraction grating effects.

The particular format of optical waveguide diffraction grating with which the present invention is concerned is derived from the format that includes a set of optical waveguides in side-by-side array, each extending from one end of the array to the other, and being of incrementally greater optical path length from the shortest at one side of the array to the longest at the other. Typically, but not necessarily, all the optical path length wavelength increments of the grating are equal. Such an optical grating, sometimes known as an arrayed waveguide grating (AWG), constitutes a component of the multiplexer described by C Dragone et al., ‘Integrated Optics N×N Multiplexer on Silicon’, IEEE Photonics Technology Letters, Vol. 3, No. 10, October 1991, pages 896-9. Referring to accompanying FIG. 1, the basic components of a 4×4 version of such a multiplexer/demultiplexer comprise an optical waveguide grating array of 2-dimensional waveguides, indicated generally at 10, whose two ends are optically coupled by radiative star 1-dimensional waveguide coupler regions, indicated schematically at 11 and 12, respectively with input and output sets of single mode 2-dimensional waveguides 13 and 14, composed respectively of waveguides 13a to 13d and 14a to 14d. (The radiative star coupler regions have been described as 1-dimensional waveguide regions because their structure provides waveguiding properties in the direction normal to the plane of the page of FIG. 1, but no waveguiding properties in the plane of the page. This contrasts with the 2-dimensional waveguides of sets 10, 13, and 14, which are described as 2-dimensional because their structure is such as to provide waveguiding properties both normal to the plane of the page, and also in the plane of the page.) Monochromatic light launched into one of the waveguides of set 13 spreads out in radiative star coupler region 11 to illuminate the input ends of all the single mode waveguides of the grating 10. At the far end of the grating 10 the field components of the emergent light interfere coherently in the far-field to produce a single bright spot at the far side of the radiative star 12. Increasing the wavelength of the light causes a slip in the phase relationship of these field components, with the result that the bright spot traverses the inboard ends of the output set of waveguides 14 as depicted at 15. If the mode size of the waveguides 14 is well matched with the size of the bright spot, then efficient coupling occurs at each of the wavelengths at which the bright spot precisely registers with one of those waveguides 14a to 14d.

The difference in optical path length between the inboard end of any one of the set of waveguides 13 and the inboard end of any one of the set of waveguides 14 via adjacent waveguides in the array 10 (the optical path length of a waveguide being the product of its physical length with its effective refractive index) determines the value of the Free Spectral Range (FSR) of the grating for this particular pair of waveguides, being the frequency range over which this difference in optical path length produces a phase difference whose value ranges over 2π radians. Accordingly the single bright spot is produced in the same position each time the optical frequency of the light is changed by an amount corresponding to a frequency difference that is an integral number of FSRs. It can thus be seen that, for optical transmission from any particular one of the set of waveguides 13 to any particular one of the set of waveguides 14, the device of FIG. 1 operates as a comb filter whose teeth are spaced in frequency by the FSR of its grating 10. Correspondingly, for optical transmission from any particular one of the set of waveguides 13 to all members of the set of waveguides 14, the device of FIG. 1 operates as a wavelength demultiplexer, while for the opposite direction of propagation of light, the device operates as a wavelength multiplexer.

The demand for increased traffic handling capacity in optical transmission systems is often met by employing frequency division multiplexing of more channels within any given frequency band, i.e. by adopting reduced channel spacing in the frequency domain, For instance increasing the number of channels from 8 to 40. This imposes a corresponding requirement for a reduced channel spacing on the part of the multiplexers and demultiplexers employed in such systems. Such a reduced channel spacing is achieved by employing a larger number of grating elements (i.e. waveguides) to form the array 10. Thus, while a grating suitable for operating in the 8-channel system may typically have between 25 to 40 waveguides to the array, the equivalent figure for the 40-channel system is an array of between 200 and 300 waveguides. However, increasing the number of grating elements of a FIG. 1 type AWG by factors as large as this has significant adverse affects upon the cost and performance of the device.

Simply because they are more numerous, the waveguides of the array 10 will necessarily occupy a larger area. Furthermore, the need to keep minimum bend radii of individual waveguides of the array to a large enough value to avoid excessive radiative loss at those bends contributes further to the enlargement of the area occupied by the array. These AWG devices are typically fabricated on single crystal silicon wafers, and since only a few of the 8-channel devices can be accommodated on a single wafer of the largest commercially available size currently available, the cost implications of increasing the area of the array are significant.

A further feature of the enlargement is that the individual waveguides of the array are, at least on average, going to be longer. Extra length is also an adverse factor. This is because the performance of the AWG in discriminating between the different wavelength multiplexed channels depends upon the accuracy achieved in manufacture in providing equal magnitude optical path length differences between adjacent pairs of waveguides of the array. Inevitably the manufacturing process involved in the creation of the waveguides of the array creates a certain amount of variation of the effective refractive index of each waveguide as a function of position along its length, and hence the exact optical path length of each waveguide is liable to differ in practice by a certain amount from its design value. Clearly, the longer that waveguide is, the greater is the magnitude that that length error is liable to be, and hence the worse the overall performance of the AWG in discriminating between the different wavelength channels.

### SUMMARY OF THE INVENTION

The present invention is directed to arrayed waveguide devices incorporating a design of waveguide grating array in which the aforementioned problems associated with increasing the number of grating elements in the array are ameliorated.

According to a first aspect of the present invention, there is provided an arrayed waveguide device, which device includes a plurality of input/output 2-dimensional optical waveguides optically coupled by a radiative star coupler 1-dimensional waveguide region with an arrayed waveguide grating constituted by a set of retro-reflector terminated 2-dimensional optical waveguides in side-by-side array defining a set of reflex optical paths extending from said star coupler region, each path being of incrementally greater optical path length from a shortest value at one side of the array to a longest value at the other.

The retro-reflector terminations of the waveguides of the grating may be constituted by reflective coatings on the ends of those waveguides, those ends extending in planes with normals that are substantially aligned with the waveguiding axes of their respective waveguides. An alternative is to provide MEMS-type reflectors adjacent the ends of the waveguides. With the appropriate type of MEMS-type reflectors, the axial separation between individual reflectors and their waveguides can be individually adjusted to optimise performance of the grating. A further alternative form that the reflectors can take is that of Bragg reflective gratings formed in the waveguides themselves.

The retro-reflector terminated waveguides of the grating can be made much shorter than half the lengths of their counterparts in the grating of FIG. 1 because the former have to be brought together at only one end instead of at both ends. This reduction in length is associated with improved performance because errors in optical path length differences between adjacent waveguides are apt to be smaller. Additionally, with the retro-reflector terminated waveguides, it is easier to reduce the deleterious effects of stray radiation. Thus, with the prior art design of FIG. 1, the stray light that is launched across star coupler region 11, but not coupled into the guided mode of any one of the waveguides of the grating 10, tends to be coupled with inconveniently high efficiency into star coupler region 12, where it degrades performance of the device; whereas with the present invention the retro-reflectors can readily be constructed in a manner that reflects little of this stray light back into the star coupler region.

According to a second aspect of the present invention, there is provided a method of demultiplexing a frequency multiplexed optical signal, in which method the multiplexed signal is divided into substantially equal intensity frequency multiplexed components launched into the members of a side-by-side array of 2-dimensional waveguides from an input 2-dimensional waveguide via a 1-dimensional waveguide from a first end thereof to a second end,

wherein the components launched into the members of the 2-dimensional waveguide array are individually retro-reflected in said members to be re-launched back into the 1-dimensional waveguide via its second end, each retro-reflected component being caused to enter the 1-dimensional waveguide with an associated delay, said delays forming an ordered set of delays with, for a given wavelength within the frequency multiplexed signal, substantially equal delay increments from a shortest delay associated with the member at one side of the array to a longest value at the other side, and

wherein the re-launched components are caused to propagate through the 1-dimensional waveguide and to be launched into a set of output 2-dimensional waveguides terminating at said first end of the 1-dimensional waveguide.

According to a third aspect of the present invention, there is provided a method of frequency multiplexing a plurality of optical signals, in which method the signals are launched in frequency order into the members of a plurality of 2-dimensional input waveguides disposed side-by-side, wherein each of the plurality of signals is divided into substantially equal intensity frequency multiplexed components launched into the members of a side-by-side array of 2-dimensional waveguides from its associated input 2-dimensional waveguide via a 1-dimensional waveguide from a first end thereof to a second end,

wherein the components launched into the members of the 2-dimensional waveguide array are individually retro-reflected in said members to be re-launched back into the 1-dimensional waveguide via its second end, each retro-reflected component being caused to enter the 1-dimensional waveguide with an associated delay, said delays forming an ordered set of delays with substantially equal delay increments from a shortest delay associated with the member at one side of the array to a longest value at the other side, and

wherein the re-launched components are caused to propagate through the 1-dimensional waveguide and to be launched into an output 2-dimensional waveguide terminating at said first end of the 1-dimensional waveguide.

Other features and advantages of the invention will be readily apparent from the following description of preferred embodiments of the invention, from the drawings and from the claims.

### BRIEF DESCRIPTION OF THE DRAWINGS

FIG. 1 (to which previous reference has already been made) schematically depicts a prior art AWG multiplexer/demultiplexer device employing an optical waveguide type diffraction grating,

FIG. 2, schematically depicts an AWG multiplexer/demultiplexer device according to the present invention

FIGS. 3 to 7, are schematic diagrams of successive stages in the construction of the AWG device of FIG. 2, and

FIG. 8 schematically depicts a modified form of the AWG device of FIG. 2.

### DETAILED DESCRIPTION OF PREFERRED EMBODIMENTS

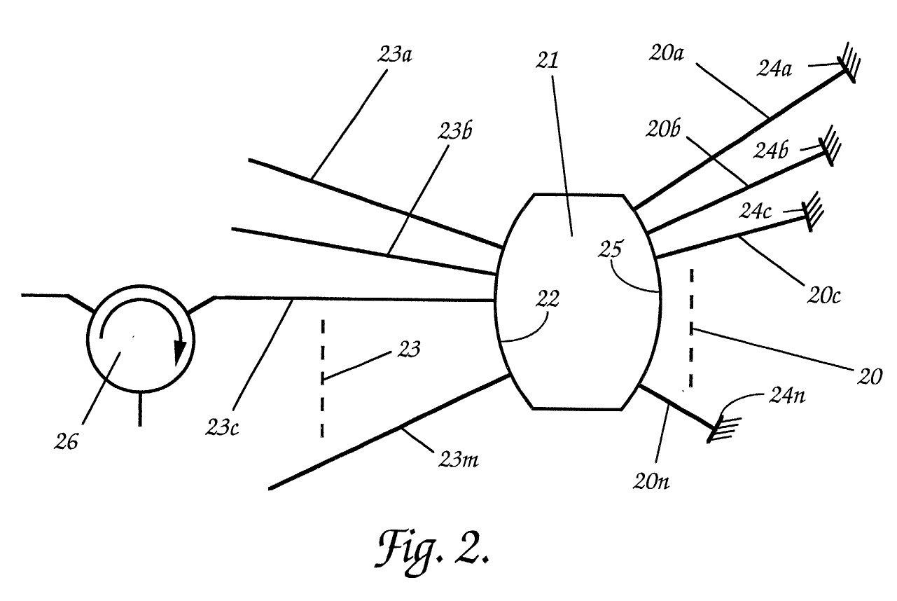

Referring to FIG. 2, the basic elements of an AWG device according to the present invention comprise a set of input/output single mode 2-dimensional optical waveguides 23 comprising waveguides 23a, 23b, 23c . . . 23m optically coupled by a radiative star coupler 1-dimensional waveguide region 21 with an arrayed waveguide grating 20 constituted by a set of single mode 2-dimensional optical waveguides 20a, 20b, 20c . . . 20n in side-by-side array. Each of the waveguides of the grating 20 is terminated with an associated retro-reflector 24a, 24b, 24c, . . . 24n. The individual physical lengths of the optical waveguides 20a, 20b, 20c . . . 20n are chosen to define a set of reflex optical paths extending from the star coupler via the individual retro-reflectors 24a, 24b, 24c, . . . 24n and back to the star coupler, each path being of incrementally greater optical path length from a shortest value at one side of the array 24a to a longest value at the other 24n.

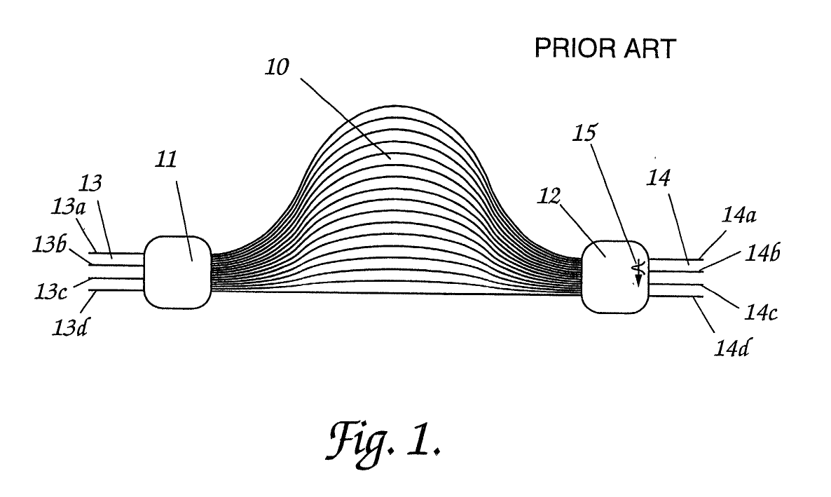

In common with the star coupler region of a prior art AWG device such as that of FIG. 1, the star coupler region 21 has an arcuate ends 22 and 25 at which the sets of waveguides 23 and 20 respectively terminate, these two ends having equal radii of curvature, each centred on a point in the surface of the other. The way in which the waveguides abut those ends is also similar. Thus, at least where the waveguides abut those ends 22 and 25, their waveguide axes are extending substantially radially, each with respect to the centre of curvature of the end to which they are respectively abutted.

In operation as a demultiplexer, light is launched into one of the input/output waveguides 23, for instance waveguide 23c. At the inboard end of that waveguide this light is launched into the star coupler region 21 where it spreads out laterally to illuminate the end of each of the waveguides of the grating 20. The light thereby launched into the waveguides 20a, 20b, 20c . . . 20n is reflected by the retro-reflectors 24a, 24b, 24c, . . . 24n to return to the star coupler region 21 where the field components of the emergent light interfere coherently in the far-field to produce, for each wavelength of the light initially launched into the AWG device, spots of light at the end 22 of the star coupler region 21. Within a wavelength range corresponding to the FSR of the AWG device, these spots of light are spread out along the end 22, and so the inboard ends of the waveguides 23a, 23b, 23c . . . 23m are positioned accordingly. In principle, the layout of the waveguides 23a, 23b, 23c . . . 23m may be such that for none of the multiplexed wavelengths for which the AWG device has been designed does the interference produce a spot registering the inboard end of the particular waveguide of the set of waveguides 23 into which the light is launched into the AWG device. Under these circumstances, this particular waveguide of the set 23 functions solely as an input waveguide. However, in practice, particularly when the multiplexed wavelengths are evenly spaced across the spectrum, it may be found more convenient to arrange matters so that the interference does produce, for one of those multiplexed wavelengths, a spot registering with the inboard end of the particular waveguide of the set of waveguides 23 into which the light is launched into the AWG device. Under these circumstances this particular waveguide functions both as an input waveguide of the AWG device, and as an output waveguide of it. The input may then be separated from the output by means of a circulator 26 connected to that waveguide.

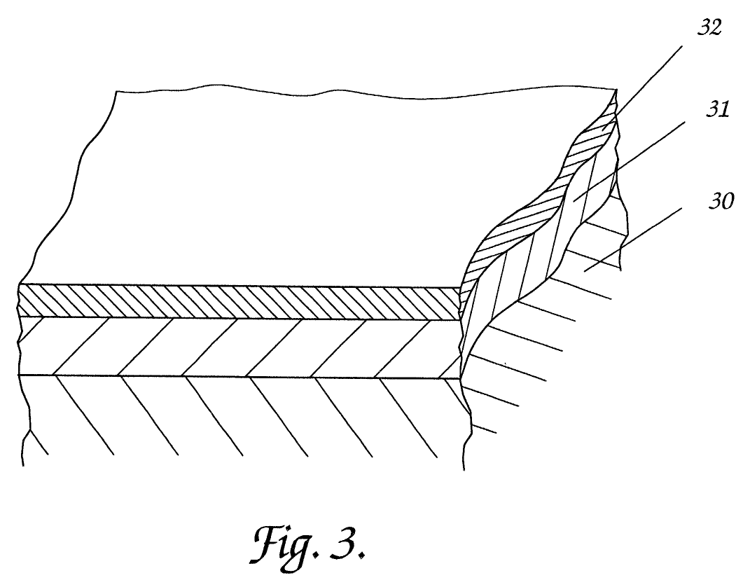

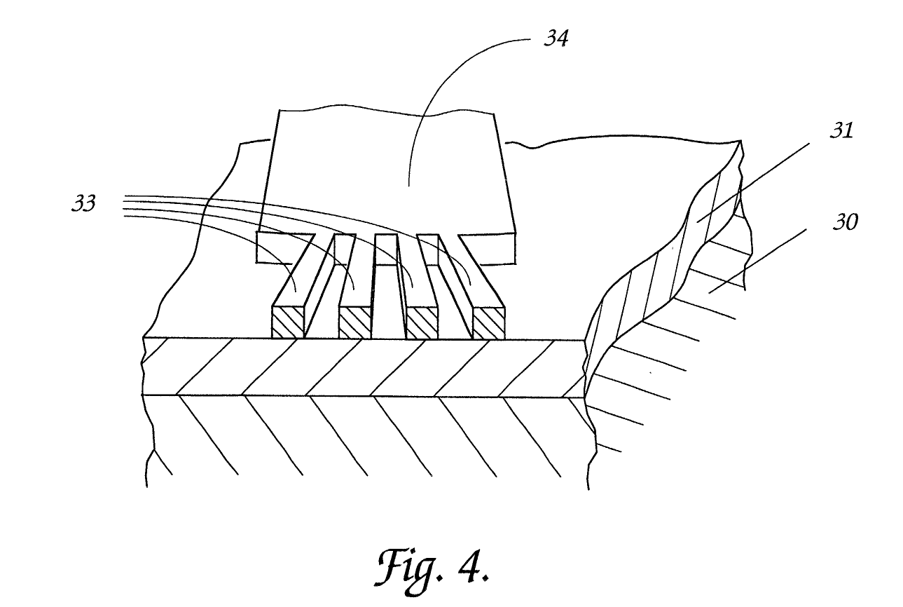

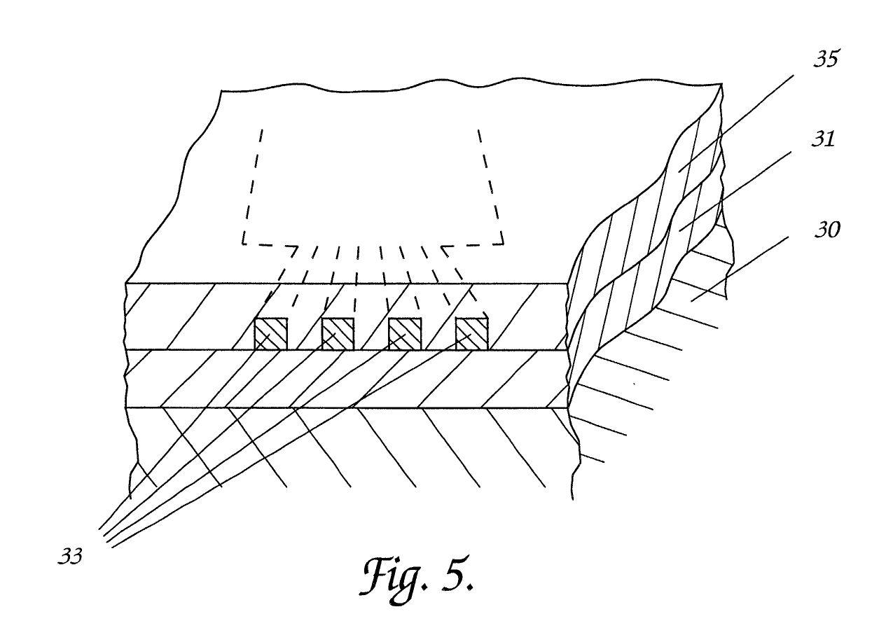

The method of constructing the AWG device of FIG. 3 uses a known form of processing to create the required configuration of optical waveguides in an integrated waveguide optics structure. Successive stages of this processing are schematically illustrated in FIGS. 3, 4, 5, 6 and 7. Referring in the first instance to FIG. 3, a layer 31 of cladding glass, typically a layer of silica, is deposited upon a planar substrate 30, typically a silicon substrate. On layer 31 is deposited a layer 32 of core glass having a refractive index a controlled amount greater than that of the cladding glass layer upon which it is deposited. Typically the core glass layer 32 is composed of doped silica. Standard photolithographic techniques are then used to pattern this layer to define the required configuration of waveguides. The portion of integrated waveguide optics structure illustrated in FIGS. 3, 4 and 5 includes portions of a number of optical waveguides 33 in each of which a waveguiding effect is provided both in the direction normal to the plane of the layer 32 and in the direction lying in the plane of that layer that is at right-angles to the axial direction of that waveguide. For convenience of illustration, only four of those waveguides 33 have been specifically illustrated in FIGS. 4 and 5, though it is to be understood that in practice a grating may typically actually have several tens, or even hundreds of such waveguides. These four waveguides 33 are shown terminating in a planar waveguide region 34, part of the star coupler region 21 of FIG. 2 in which there is still a waveguiding effect in the direction normal to the plane of layer 32, but in which light is able to radiate laterally from any one of the waveguides 33. After completion of the patterning of layer 32, it is covered with a further layer 35 of cladding glass whose refractive index is less than that of core glass layer 32, preferably having an index matched with that of cladding glass layer 31. Typically this cladding glass layer 35 is also made of doped silica, the principal or sole dopant in this instance is boron, whose purpose is not to raise the refractive index of the host material, but to lower its flow temperature, and to provide a substantial match between the thermal expansion coefficient of the material of layer 35 and that of the underlying silicon substrate 30.

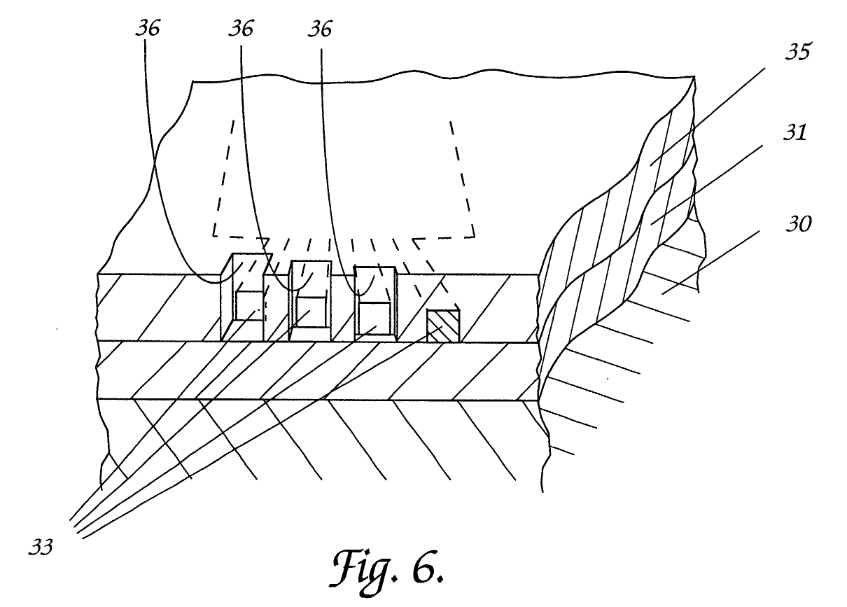

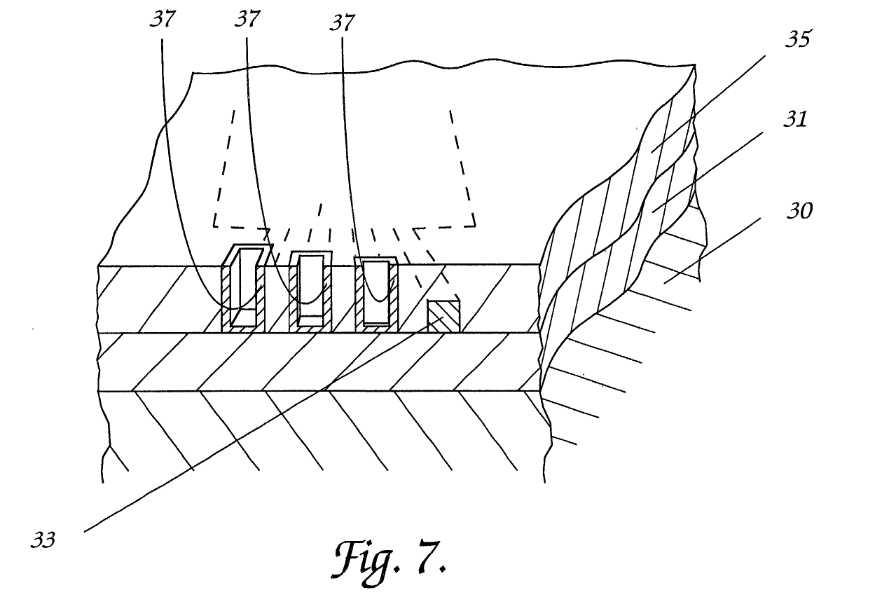

When the waveguides 30 are initially formed as described above with particular reference to FIG. 4, the maskwork employed for the purpose delineates waveguides for the grating array that are individually longer than is required for the finished product. Using further maskwork (not shown), these grating array waveguides are photolithographically cut back to length by the etching of a set of troughs (FIG. 6) with smooth substantially vertical end walls 36 (i.e. walls with normals substantially aligned with the respective axes of the waveguides that they terminate) extending through the thickness of the upper cladding glass layer 35 at least as far as, or penetrating into, the lower cladding glass layer 31. A suitable etching process for this purpose comprises reactive ion etching in a plasma chamber using fluorocarbons as a source of fluorine and fluorine radicals. A reflective coating 37 (FIG. 7), typically of gold or silver, is then deposited in these troughs to cover the end walls 36. A suitable coating process for this purpose comprises thermal evaporation or sputtering.

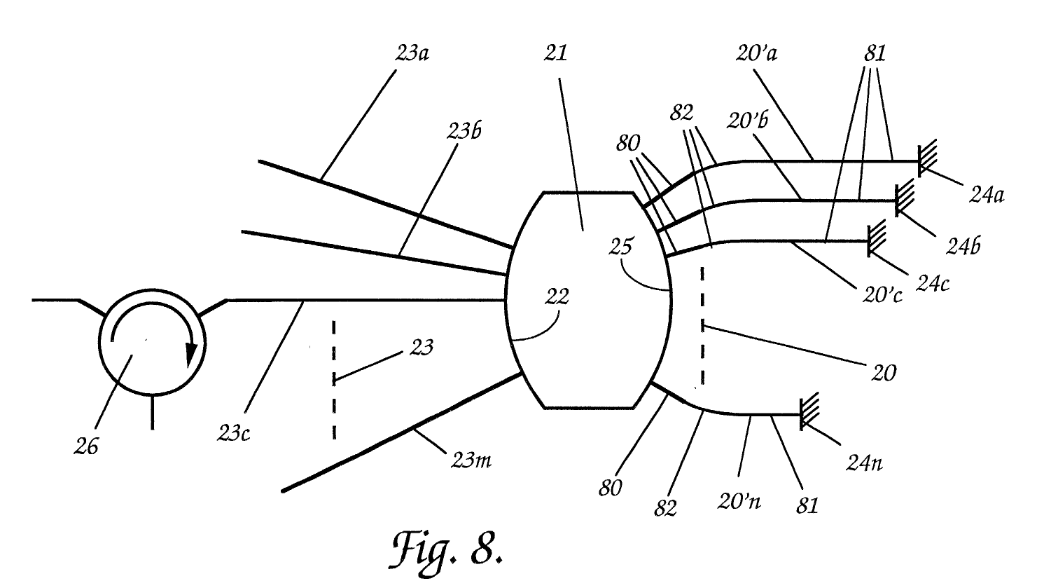

In FIG. 2 each of the individual grating waveguides 20a, 20b, 20c . . . 20n of the grating array is represented as being rectilinear throughout its whole length. Using the specific method of manufacture described above, the determination of the actual length of each of these waveguides involves the performance of two masking processes. Since these grating waveguides extend in different directions, it is evident that a displacement of the positioning of the second mask (the mask employed for cutting the grating waveguides to length) from its intended position with respect to the positioning of the first mask (the mask which inter alia delineates the star coupler region 21) will have the effect of altering the relative optical lengths of those waveguides. This means that the relative positioning of the two masks is of critical importance in the production of a high quality product. This problem is greatly eased by adopting a waveguide configuration for the grating waveguides, such as that depicted in FIG. 8. In this FIG. 8 the individual waveguides 20a, 20b, 20c . . . 20n of the grating array are replaced by individual waveguides 20′a, 20′b, 20′c . . . 20′n, each of which is not rectilinear throughout its whole length, but has two rectilinear portions 80 and 81 connected by a gently curved portion 82. The rectilinear portion 80 of each of the waveguides 20′a, 20′b, 20′c . . . 20′n of FIG. 8 terminates at the star coupler region 21 at the same position as its counterpart waveguides 20a, 20b, 20c . . . 20n of the AWG device of FIG. 2 terminates at its star coupler region 21, and extends in the same direction as that counterpart. The rectilinear portions 81 all extend in the same direction. By ensuring that each of the retro-reflectors is located to terminate its associated grating waveguide 20′a, 20′b, 20′c . . . 20′n in its rectilinear portion 81, it is seen that a lateral physical displacement in the positioning of the second increases (or decreases) the physical length of each of the grating waveguides 20′a, 20′b, 20′c . . . 20′n by the same amount. Provided that these waveguides have the same effective refractive index in their rectilinear portions 81, it is seen that such a displacement of the positioning of the second mask with respect to that of the first has no effect upon the optical path length differences between adjacent grating waveguides 20′a, 20′b, 20′c . . . 20′n.

Both in FIG. 2, and in FIG. 8, each of the individual input/output waveguides 23a, 23b, 23c . . . 23m of the grating array is also represented as being rectilinear throughout its whole length. Though not specifically illustrated, each of these waveguides will typically also incorporate a rectilinear portion at each end, these rectilinear portions being joined by a curved portion, in this case of a generally swan-necked portion. This is in order to be able to bring the outboard ends of those waveguides into a side-by-side array at the edge of the substrate 30, and so facilitate the making of optical edge connection with those waveguides.

1. An arrayed waveguide device, which device includes a plurality of input/output 2-dimensional optical waveguides optically coupled by a radiative star coupler 1-dimensional waveguide region with an arrayed waveguide grating constituted by a set of retro-reflector terminated 2-dimensional optical waveguides in side-by-side array defining a set of reflex optical paths extending from said star coupler region, each path being of incrementally greater optical path length from a shortest value at one side of the array to a longest value at the other.

2. An arrayed waveguide device as claimed in claim 1, wherein each retro-reflector is constituted by an end facet of its associated grating waveguide, which facet is provided with a reflective coating.

3. An arrayed waveguide device as claimed in claim 2, wherein said facets extend in substantially parallel planes.

4. A method of demultiplexing a frequency multiplexed optical signal, in which method the multiplexed signal is divided into substantially equal intensity frequency multiplexed components launched into the members of a side-by-side array of 2-dimensional waveguides from an input 2-dimensional waveguide via a 1-dimensional waveguide from a first end thereof to a second end,
wherein the components launched into the members of the 2-dimensional waveguide array are individually retro-reflected in said members to be re-launched back into the 1-dimensional waveguide via its second end, each retro-reflected component being caused to enter the 1-dimensional waveguide with an associated delay, said delays forming an ordered set of delays with, for a given wavelength within the frequency multiplexed signal, substantially equal delay increments from a shortest delay associated with the member at one side of the array to a longest value at the other side, and
wherein the re-launched components are caused to propagate through the 1-dimensional waveguide and to be launched into a set of output 2-dimensional waveguides terminating at said first end of the 1-dimensional waveguide.

5. A method of frequency multiplexing a plurality of optical signals, in which method the signals are launched in frequency order into the members of a plurality of 2-dimensional input waveguides disposed side-by-side, wherein each of the plurality of signals is divided into substantially equal intensity frequency multiplexed components launched into the members of a side-by-side array of 2-dimensional waveguides from its associated input 2-dimensional waveguide via a 1-dimensional waveguide from a first end thereof to a second end,
wherein the components launched into the members of the 2-dimensional waveguide array are individually retro-reflected in said members to be re-launched back into the 1-dimensional waveguide via its second end, each retro-reflected component being caused to enter the 1-dimensional waveguide with an associated delay, said delays forming an ordered set of delays with substantially equal delay increments from a shortest delay associated with the member at one side of the array to a longest value at the other side, and
wherein the re-launched components are caused to propagate through the 1-dimensional waveguide and to be launched into an output 2-dimensional waveguide terminating at said first end of the 1-dimensional waveguide.
